(19) United States
(12) Patent Application Publication
(10) Pub. No.: US 2026/0203783 A1
(43) Pub. Date: Jul. 16, 2026

(54) DEFENSE DRIVING EVALUATION APPARATUS AND DEFENSE DRIVING EVALUATION SYSTEM

(71) Applicant: Honda Motor Co., Ltd., Tokyo (JP)

(72) Inventor: Masayuki Sato, Saitama (JP)

(21) Appl. No.: 19/443,326

(22) Filed: Jan. 8, 2026

(30) Foreign Application Priority Data
Jan. 14, 2025 (JP) 2025-004904

(51) Int. Cl. G06Q 30/0207; B60Q 1/34; B60W 30/18; B60W 40/09; B60W 50/00; B60W 50/14

(52) U.S. Cl. CPC G06Q 30/0207; B60Q 1/346; B60W 30/18127; B60W 40/09; B60W 50/0097; B60W 50/14; B60W 2050/146; B60W 2520/10; B60W 2554/4046; B60W 2556/45

(57) ABSTRACT

A defense driving evaluation apparatus, includes: a sensor configured to detect a behavior of a vehicle; and an in-vehicle device having a processor and a memory coupled to the processor. The in-vehicle device is configured to perform: recognizing a surrounding situation of the vehicle; acquiring driving action information relating to a driving action of a driver of the vehicle based on the behavior of the vehicle and the surrounding situation of the vehicle; determining whether the driving action corresponds to a defense driving using the driving action information; classifying the defense driving according to the behavior of the vehicle and the surrounding situation of the vehicle when it is determined that the driving action corresponds to the defense driving; and providing a benefit to the driver based on a classification result.

### CROSS-REFERENCE TO RELATED APPLICATION

This application is based upon and claims the benefit of priority from Japanese Patent Application No. 2025-004904 filed on Jan. 14, 2025, the content of which is incorporated herein by reference.

### BACKGROUND OF THE INVENTION

### Field of the Invention

The present invention relates to a defense driving evaluation apparatus and a defense driving evaluation system that evaluate defense driving of a driver.

### Description of the Related Art

As this type of technology, a technology for performing driving evaluation based on information obtained by an in-vehicle device including various sensors is known (JP2023-161387A). Point-addition evaluation advantageous to the driver is performed the longer the duration of excellent driving without the occurrence of violation.

In the conventional technology, for example, driving without a traffic violation is regarded as exemplary driving, and when a driver performs exemplary driving, it is evaluated as excellent driving. However, it is not sufficient to enlighten the driver about driving to avoid a situation where an accident is likely to occur, that is, so-called defense driving. Enlightenment of defense driving is also expected to greatly contribute to traffic safety.

### SUMMARY OF THE INVENTION

An aspect of the present invention is a defense driving evaluation apparatus, including: a sensor configured to detect a behavior of a vehicle; and an in-vehicle device having a processor and a memory coupled to the processor. The in-vehicle device is configured to perform: recognizing surrounding situation of the vehicle; acquiring driving action information relating to a driving action of a driver of the vehicle based on the behavior of the vehicle and the surrounding situation of the vehicle; determining whether the driving action corresponds to a defense driving using the driving action information; classifying the defense driving according to the behavior of the vehicle and the surrounding situation of the vehicle when it is determined that the driving action corresponds to the defense driving; and providing a benefit to the driver based on a classification result.

Another aspect of the present invention is a defense driving evaluation system, including: an in-vehicle device mounted on each of a plurality of vehicles and configured to perform recognizing surrounding situation of each of the plurality of vehicles, acquiring driving action information relating to a driving action of a driver of each of the plurality of vehicles based on a behavior of each of the plurality of vehicles detected by a sensor and the surrounding situation of each of the plurality of vehicles, and communicating with a server device; and the server device configured to perform communicating with the in-vehicle device mounted on each of the plurality of vehicles, determining whether the driving action of the driver of each or the plurality of vehicles corresponds to a defense driving using the driving action information from each of the plurality of vehicles, classifying the defense driving according to the behavior of each of the plurality of vehicles and the surrounding situation of each of the plurality of vehicles when it is determined that the driving action corresponds to the defense driving, and providing a benefit to the driver of each of the plurality of vehicles based on a classification result.

### BRIEF DESCRIPTION OF THE DRAWINGS

The objects, features, and advantages of the present invention will become clearer from the following description of embodiments in relation to the attached drawings, in which:

FIG. 1A is a schematic diagram illustrating an example of a defense driving evaluation system;

FIG. 1B is a schematic diagram illustrating an example of a vehicle equipped with an IVI system;

FIG. 2A is a block diagram illustrating a configuration of a main part of an in-vehicle device;

FIG. 2B is a block diagram illustrating a configuration of a main part of a vehicle sensor group and a vehicle interior camera;

FIG. 2C is a block diagram illustrating a configuration of a main part of an input device and an output device;

FIG. 3 is a flowchart for describing an example of a defense driving evaluation processing by a program; and

FIG. 4 is a block diagram illustrating a configuration of a main part of an information processing device.

### DETAILED DESCRIPTION OF THE INVENTION

### Overview

A defense driving evaluation apparatus according to the invention evaluates defense driving of a driver who drives a vehicle. In the embodiment, the defense driving refers to a driving action for avoiding danger that may lead to an accident, and corresponds to the driving actions exemplified below. In the description, the vehicle may be referred to as an own vehicle in order to distinguish the vehicle from another vehicle.
(1) Before the own vehicle passes through an intersection of low visibility or the like, the operation of the accelerator pedal of the own vehicle is loosened to prepare for the brake pedal operation.
(2) At the time of traffic congestion, the traveling lane of the own vehicle is selected according to the size of other vehicles around the own vehicle.
(3) The own vehicle makes way for the following vehicle pressing the own vehicle.
(4) The traveling speed of the own vehicle is suppressed at the time of severe weather.
(5) In a case where there is a possibility that the own vehicle decelerates, attention is called toward other vehicles and the like.

In the embodiment, a defense driving evaluation apparatus is exemplified as one of functions of an In-Vehicle Infotainment (IVI) system provided in an own vehicle. The defense driving evaluation apparatus predicts a future danger of the traveling own vehicle based on detection information by a sensor or the like provided in the own vehicle, and when the driver performs a driving action for avoiding the predicted danger, evaluates the driving action as defense driving.

The information obtained by the defense driving evaluation apparatus may be sent to an external device via a public communication network as the defense driving information and managed by the external device. A defense driving evaluation system including such a defense driving evaluation apparatus, a public communication network, and an external device will be described in more detail with reference to the drawings.

### Configuration Example of Defense Driving Evaluation System

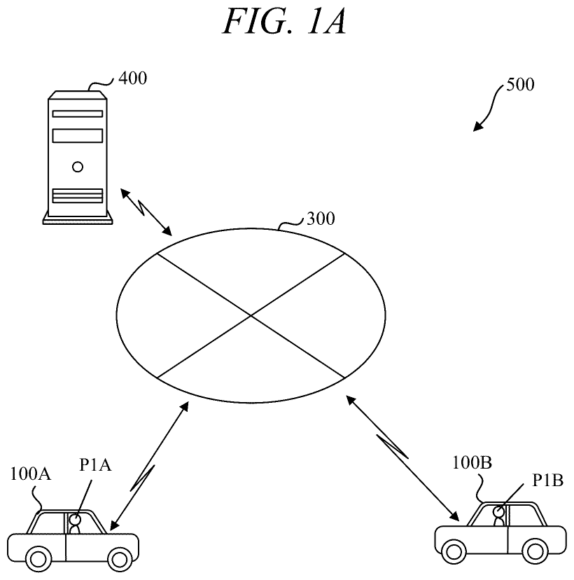

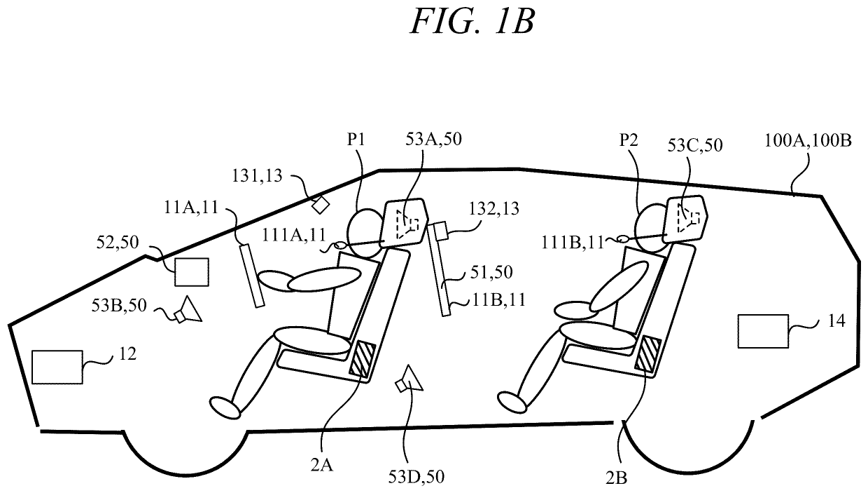

FIG. 1A is a schematic diagram illustrating an example of a defense driving evaluation system 500. In the embodiment, a system including a vehicle 100A driven by a driver P1A, a vehicle 100B driven by a driver P1B, a public communication network 300, and a server device 400 is exemplified as the defense driving evaluation system 500. In each vehicle 100A, 100B, the defense driving is evaluated by each of the defense driving evaluation apparatus.

### Configuration in Vehicle

FIG. 1B is a schematic diagram illustrating an example of the vehicle 100A equipped with an IVI system including a defense driving evaluation function as one of the functions. It is assumed that the vehicle 100A and the vehicle 100B have the same configuration. Therefore, in the following description, the vehicles 100A and 100B are referred to as a vehicle 100, the drivers P1A and P1B are referred to as a driver P1, and passengers P2A and P2B are referred to as a passenger P2.

The IVI system includes an in-vehicle device 14, a vehicle sensor group 12, a display unit 51, a projection unit 52, and voice reproduction units 53A to 53D constituting an output device 50, operation detection units 11A and 11B and microphones 111A and 111B constituting an input device 11, a front seat camera 131 and a rear seat camera 132 constituting a vehicle interior camera 13, a terminal 2A used by the driver P1 in a front seat of the vehicle interior, and a terminal 2B used by the passenger P2 in a rear seat of the vehicle interior. FIG. 1B illustrates a case where the driver P1 and the passenger P2 are seated in the vehicle interior.

The in-vehicle device 14 and the terminals 2A and 2B are configured to be able to perform, for example, Ultra-Wide Band (UWB) wireless communication. The UWB wireless communication is a communication system that enables highly accurate positional measurement using an ultra-wide band frequency bandwidth. In the embodiment, the positions of the terminals 2A and 2B in the vehicle interior can be detected with high accuracy.

The in-vehicle device 14, the output device 50, the input device 11, the vehicle sensor group 12, and the vehicle interior camera 13 are configured to be able to perform wired communication by a Controller Area Network (CAN) or the like.

The terminals 2A and 2B are, by way of example, smartphones or the like used by each of the driver P1 and the passenger P2. The terminals 2A and 2B may be held by a holder (not illustrated) installed on a seat on which each person sits.

Although two terminals 2A and 2B are illustrated as terminals used by the driver P1 and the passenger P2, the actual number of terminals varies depending on the number of occupants, and may be four if there are four occupants. In addition, the number of cameras constituting the vehicle interior camera 13, the number of operation detection units and microphones constituting the input device 11, and the number of display units, projection units, and voice reproduction units constituting the output device 50 may also be appropriately changed according to the number of occupants.

In the IVI system, if a button corresponding to the defense driving evaluation is touch-operated from among a plurality of menu buttons (that may be referred to as icons) displayed on the output device 50, or if a voice corresponding to the defense driving evaluation is input from the microphones 111A and 111B constituting the input device 11 in a state where the output device 50 (projection unit 52, display unit 51) is caused to project or display an operation menu screen (not illustrated), the in-vehicle device 14 starts an operation as the defense driving evaluation apparatus 200.

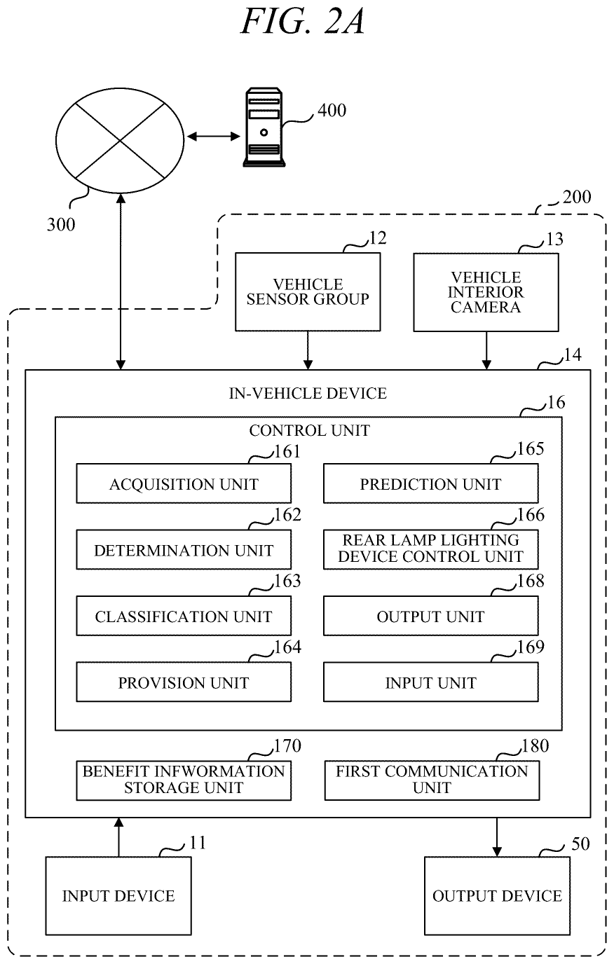

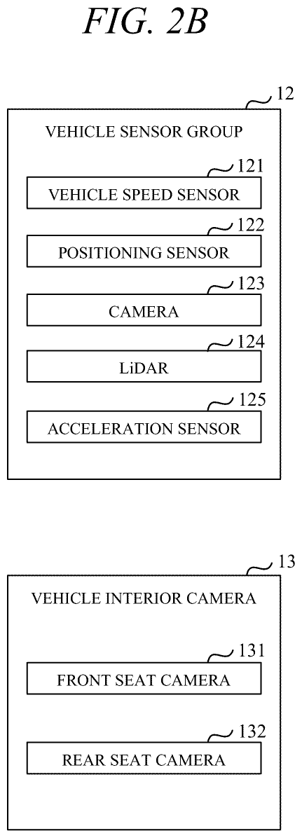

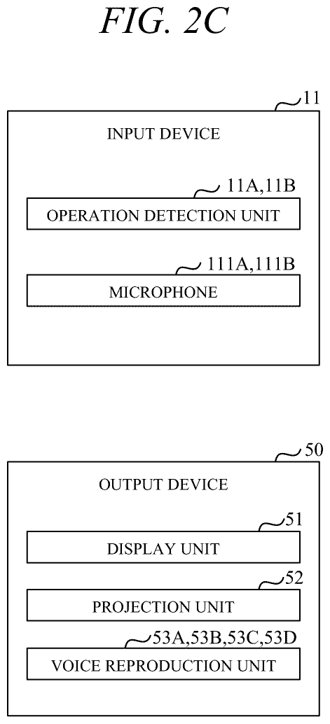

Hereinafter, the function of the in-vehicle device 14 serving as the defense driving evaluation apparatus 200 will be mainly described. FIGS. 2A to 2C are diagrams illustrating a configuration example of each unit in FIG. 1B.

### In-Vehicle Device

FIG. 2A is a block diagram illustrating a configuration of a main part of the in-vehicle device 14. The in-vehicle device 14 includes a control unit 16 that substantially functions as a Micro Processing Unit (MPU) of the IVI system, and reads and executes a predetermined program stored in a storage unit (not illustrated) in the control unit 16 to perform various information processing, control processing, and the like necessary in the in-vehicle device 14.

In FIG. 2A, the in-vehicle device 14 includes the control unit 16, a benefit information storage unit 170, and a first communication unit 180. In a case of starting the operation of the defense driving evaluation apparatus 200, the control unit 16 reads and executes an application program for the defense driving evaluation apparatus 200 stored in a storage unit in the control unit 16, thereby performing various types of information processing, control processing, and the like necessary for the defense driving evaluation apparatus 200.

The control unit 16 includes, as functional configurations for the defense driving evaluation, an acquisition unit 161, a determination unit 162, a classification unit 163, a provision unit 164, a prediction unit 165, a rear lamp lighting device control unit 166, an output unit 168, and an input unit 169.

### Acquisition Unit

The acquisition unit 161 acquires information regarding the driving action of the driver P1 of the vehicle 100 based on the behavior of the vehicle 100 detected by the vehicle sensor group 12 serving as a detection unit and the surrounding situation of the vehicle 100 recognized by the control unit 16 serving as a recognition unit based on the detection data from the vehicle sensor group 12.

Note that, in the embodiment, as an example, when the driver P1 and the passenger P2 get on the vehicle 100, the in-vehicle device 14 may speak to the driver P1 and the passenger P2 via the voice reproduction units 53A to 53D constituting the output device 50, the microphones 111A and 111B constituting the input device 11 may collect voices (e.g., introducing one's own name) responded by the driver P1 and the passenger P2, and the front seat camera 131 and the rear seat camera 132 constituting the vehicle interior camera 13 may photograph the driver P1 and the passenger P2.

The in-vehicle device 14 associates (may be said to relate) the faces of the driver P1 and the passenger P2, the names of the driver P1 and the passenger P2, and the frequency components of the voice uttered by the driver P1 and the passenger P2, so that it is possible to identify the faces, the names, and the voices of all the occupants in the vehicle interior.

The in-vehicle device 14 manages the information regarding the driving action acquired as the defense driving evaluation apparatus 200 as driving information of the driver P1 seated on the driver's seat.

### Determination Unit

The determination unit 162 determines whether the driving action of the driver P1 corresponds to the defense driving using the information regarding the driving action acquired by acquisition unit 161. As exemplified above, defense driving refers to the driving action for avoiding danger that may lead to an accident.

### Classification Unit

The classification unit 163 classifies the defense driving. More specifically, the driving action determined to correspond to the defense driving by the determination unit 162 is classified based on the behavior of vehicle 100 and the surrounding situation of the vehicle 100. For example, the combination of the behavior of the vehicle 100 and the surrounding situation of the vehicle 100 is divided into a predetermined number of patterns indicating the relationship between the behavior of the vehicle 100 and the surrounding situation of the vehicle 100, and classified according to the driving action performed in each pattern and the result of the driving action (presence or absence of sudden deceleration, presence or absence of abrupt steering, magnitude of acceleration, etc.).

### Provision Unit

The provision unit 164 provides a benefit serving as an incentive to the driver P1 who has performed defense driving. The benefit is content for awarding an act of defense driving. The information indicating benefit may be referred to as benefit information.

The provision unit 164 selects content of a rank related to a classification result by the classification unit 163 from among a plurality of pieces of content prepared in advance, and provides the content to the driver P1. The content provided to the driver P1 can be viewed by the driver P1 in the vehicle interior.

### Case 1

As a specific example, there is exemplified a scene in which when the traveling vehicle 100 reaches a blind area such as an intersection and the driver P1 loosens the accelerator pedal and advances the vehicle 100 so as to cope with sudden jumping out, the driver P1 performs a gentle brake operation because a pedestrian jumped out from the blind area to avoid danger.

The provision unit 164 gives rating of +3 points on the driver P1 of Case 1 on the assumption that the driver has predicted the danger and has performed an appropriate driving action to cope with sudden jumping out.

### Case 2

As another example, there is exemplified a scene in which the traveling vehicle 100 reaches a blind area such as an intersection and the driver P1 loosens the accelerator pedal and advances the vehicle 100 so as to cope with sudden jumping out, but a pedestrian did not jump out from the blind area.

The provision unit 164 gives rating of +1 point on the driver P1 of Case 2 on the assumption that the driver has predicted the danger of the blind area and an appropriate driving action can be taken.

### Case 3

As another further example, there is exemplified a scene in which when the traveling vehicle 100 reaches a blind area such as an intersection and the driver P1 advances the vehicle 100 without loosening the accelerator pedal, an extremely strong brake operation is performed because a pedestrian jumped out from the blind area to avoid danger.

The provision unit 164 gives rating of adding a score of 0 (zero) on the driver P1 of Case 3 on the assumption that as a result of approaching without being conscious of a blind area without predicting danger, the driver has performed a sudden operation in a panicking manner due to jumping out.

The provision unit 164 takes statistics of the rating as exemplified, selects and provides content matching the rating result (in other words, conforming to the classification result by the classification unit 163) from among a plurality of pieces of content prepared in advance for each rank of the rating.

Note that the provided content may be, for example, content praising the driver, video content (moving image, still image, text display, icon display, graphic display, etc.), or sound content. The sound content includes voice content and music content.

### Prediction Unit

The prediction unit 165 predicts a future danger of the vehicle 100 based on the behavior of the vehicle 100 and the surrounding situation of the vehicle 100. This prediction is performed on the in-vehicle device 14 side separately from the prediction of the danger performed by the driver P1. The prediction by the prediction unit 165 can be used as a material for determination of the defense driving by the determination unit 162.

### Rear Lamp Lighting Device Control Unit

In a case where a regenerative braking control unit (not illustrated) provided in the vehicle 100 generates regenerative braking (in the case of an engine vehicle, an engine brake may be used) by the driver P1 performing a driving action to prepare for avoiding danger such as loosening an accelerator pedal, and the vehicle sensor group 12 detects that deceleration has been performed at a predetermined deceleration, the rear lamp lighting device control unit 166 performs blinking control of at least one rear lamp lighting device (hazard lamp, brake lamp) of the vehicle 100.

### Output Unit

The output unit 168 outputs a video signal to the output device 50 when reproducing video content serving as benefit information according to an instruction from the driver P1. As a result, the video based on the video signal output from the output unit 168 is displayed on the display unit constituting the output device 50.

In addition, the output unit 168 outputs a reproduction signal to the output device 50 when reproducing sound content serving as benefit information according to an instruction from the driver P1. As a result, the voice based on the reproduction signal output from the output unit 168 is reproduced by the speaker or the like constituting the output device 50.

### Input Unit

The input unit 169 inputs voices uttered by the driver P1 and the passenger P2. More specifically, the voice signal of the driver P1 collected by the microphone 111A is input. Furthermore, the voice signal of the passenger P2 collected by the microphone 111B is input.

### Benefit Information Storage Unit

The benefit information storage unit 170 stores benefit information as content to be given to the driver P1. A plurality of types of benefit information are prepared for each rank of the above-described rating. Note that a plurality of types of different contents may be prepared in the same rank in correspondence with the same rating. This is to prevent the same content from being redundantly given when the driver P1 receives an award of the same rank as the award received in the past. When the driver P1 receives the award, the driver P1 can view only the given content from among the contents stored in the benefit information storage unit 170.

The provision unit 164 normally selects content to be provided to the driver P1 from among the contents stored in the benefit information storage unit 170. However, for example, in order to enrich the types of content, not only the content stored in the benefit information storage unit 170 but also content acquired from an external device such as the server device 400 via the public communication network 300 may be provided to the driver P1.

Note that, instead of the benefit information, content information introducing a dangerous scene that the traveling vehicle 100 has a possibility of encountering may be stored in the benefit information storage unit 170. Specifically, as an example of the future danger predicted by the prediction unit 165, information of content introducing a dangerous scene such as a pedestrian jumping out from the shade of a utility pole or a crossing person appearing from a congested opposite lane is stored.

For example, when the score added to the driver P1 is 0 (zero) in the above-described rating, corresponding content introducing the dangerous scene may be provided to the driver P1.

### First Communication Unit

The first communication unit 180 includes a short-range wireless communication module (not illustrated) that performs wireless communication with the terminals 2A and 2B and a wired communication module (not illustrated) that performs wired communication by CAN or the like. The UWB wireless communication system described above may be adopted for the short-range wireless communication module.

FIG. 2B is a block diagram illustrating a configuration of a main part of the vehicle sensor group 12 and the vehicle interior camera 13 of the vehicle 100.

### Vehicle Sensor Group

The vehicle sensor group 12 includes a vehicle speed sensor 121, a positioning sensor 122, a camera 123, a LiDAR 124, and an acceleration sensor 125. An operation detection sensor (not illustrated) for detecting operations on various driving operators may also be included in the vehicle sensor group 12.

### Vehicle Speed Sensor

The vehicle speed sensor 121 detects a vehicle speed of the vehicle 100 and outputs vehicle speed information to the in-vehicle device 14.

### Positioning Sensor

The positioning sensor 122 detects the current position of the vehicle 100 based on positioning signals from Global Positioning System (GPS) satellites, quasi-zenith satellites, or the like. The positioning sensor 122 outputs a signal indicating the current position to the in-vehicle device 14 as position information.

### Camera

The camera 123 photographs the surroundings of the vehicle 100. The camera 123 outputs data of a subject image to the in-vehicle device 14 as image information. The camera 123 can capture a still image or a moving image.

### LiDAR

The Light Detection And Ranging (LiDAR) 124 performs scanning by changing an irradiation angle of laser light to be emitted, and measures detection of an object, a distance to the object, and the like based on the position information of each detection point. The measurement data is output to the in-vehicle device 14.

### Acceleration Sensor

The acceleration sensor 125 detects an acceleration of the vehicle 100 and outputs acceleration information to the in-vehicle device 14.

### Vehicle Interior Camera

The vehicle interior camera 13 includes the front seat camera 131 and the rear seat camera 132. The front seat camera 131 photographs the upper body of the driver P1 sitting in the front seat, and outputs data of the subject image to the in-vehicle device 14 as image information. The rear seat camera 132 photographs the upper body of the passenger P2 sitting in the rear seat, and outputs data of the subject image to the in-vehicle device 14 as image information.

FIG. 2C is a block diagram illustrating a configuration of a main part of the input device 11 and the output device 50 of the in-vehicle device 14 of the vehicle 100.

### Input Device

The input device 11 includes operation detection units 11A and 11B and microphones 111A and 111B.

### Operation Detection Unit

The operation detection unit 11A is operated by the driver P1 in the front seat, and outputs an operation signal to the in-vehicle device 14. The operation detection unit 11A may be configured as a pointing device that interlocks with a projection image projected by the projection unit 52 described later. The operation detection unit 11B is provided on the display surface of the display unit 51. The operation detection unit 11B is operated by the passenger P2 in the rear seat and outputs an operation signal indicating a touch position to the in-vehicle device 14.

### Microphone

The microphone 111A collects voice uttered by the driver P1 in the front seat and outputs a voice signal to the in-vehicle device 14. The microphone 111B collects voice uttered by the passenger P2 in the rear seat and outputs a voice signal to the in-vehicle device 14.

### Output Device

The output device 50 includes the display unit 51, the projection unit 52, and the voice reproduction unit 53. The output device 50 is used, for example, for displaying an operation menu screen, reproducing contents, or the like.

### Display Unit

The display unit 51 has a screen such as a liquid crystal display, and displays image information based on a display signal output from the in-vehicle device 14. The image information includes the operation menu screen, an image of video content, and the like.

### Projection Unit

The projection unit 52 includes, for example, a head-up display (HUD) to be projected on a windshield or the like, and projects image information based on a projection signal output from the in-vehicle device 14. The image information includes the operation menu screen, an image of video content, and the like.

### Voice Reproduction Unit

The voice reproduction units 53A to 53D are configured as speakers for reproducing and outputting voice and the like, and reproduce sound content and the like based on a reproduction signal output from the in-vehicle device 14. Note that a voice output unit that outputs a content reproduction signal to a headphone (not illustrated) or the like may be provided.

### Description of Flowchart

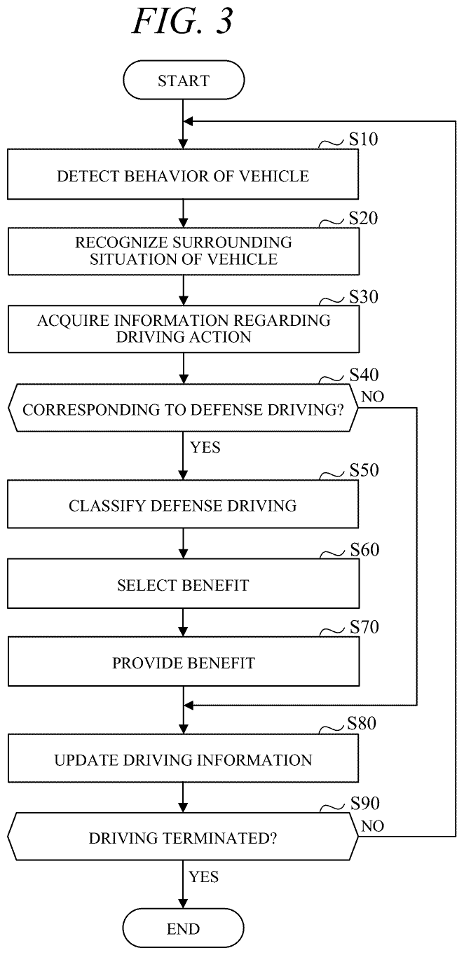

FIG. 3 is a flowchart for describing an example of a defense driving evaluation processing by a program executed by the MPU (control unit 16) of the in-vehicle device 14. For example, in a case where a “defense driving evaluation” button is operated on the operation menu screen (not illustrated), the control unit 16 of the in-vehicle device 14 executes a program that causes the IVI system to function as the defense driving evaluation apparatus 200.

In S10 (S: processing step) of FIG. 3, the control unit 16 detects the behavior of vehicle 100 using vehicle group 12, and proceeds to S20.

In S20, the control unit 16 recognizes the surroundings of the vehicle 100 based on the detection data by the vehicle sensor group 12, and proceeds to S30.

In S30, the control unit 16 causes acquisition unit 161 to acquire information regarding the driving action of driver P1 of vehicle 100 based on the behavior of vehicle 100 and the surrounding situation of the vehicle 100, and proceeds to S40.

In S40, the control unit 16 causes the determination unit 162 to determine whether the driving action of the driver P1 corresponds to defense driving. The control unit 16 makes an affirmative determination in S40 and proceeds to S50 if the driving action corresponds to the defense driving, and makes a negative determination in S40 and proceeds to S80 if the driving action does not correspond to the defense driving.

In S50, the control unit 16 causes the classification unit 163 to classify the defense driving, and proceeds to S60.

In S60, the control unit 16 causes the provision unit 164 to select a benefit of a rank according to a classification result by the classification unit 163 from among a plurality of pieces of benefit information (content) stored in the benefit information storage unit 170, and proceeds to S70.

In S70, the provision unit 164 provides the selected benefit to the driver P1, and proceeds to S80. In the embodiment, placing the content serving as the selected benefit in a state where the content can be viewed from the driver P1 is referred to as provision.

In S80, the control unit 16 updates the driving information related to the driver P1, and proceeds to S90. For example, the control unit 16 records, in a storage unit (not illustrated) in the control unit 16, when and where the driver P1 of the vehicle 100 traveled, what kind of driving action the driver P1 took, what was the rating for the defense driving, whether an award was given, what benefit (content) was given, and the like as the driving information for each driver. In S80, updating and recording of adding the latest driving information to such driving information for each driver are performed.

In S90, the control unit 16 determines whether the driving is terminated. In a case where a predetermined terminating operation is performed, the control unit 16 makes an affirmative determination in S90 and terminates the processing according to FIG. 3. In a case where the terminating operation is not performed, the control unit 16 makes a negative determination in S90 and returns to S10. In the case of returning to S10, the control unit 16 repeats the above-described processing.

According to the embodiment described above, the following effects are obtained.
(1) A defense driving evaluation apparatus 200 includes a vehicle sensor group 12 serving as a detection unit that detects the behavior of the vehicle 100, a control unit 16 serving as a recognition unit that recognizes the surroundings of the vehicle 100, an acquisition unit 161 that acquires information regarding the driving action of the driver P1 of the vehicle 100 based on the behavior of the vehicle 100 detected by the vehicle sensor group 12 and the surrounding situation of the vehicle 100 recognized by the control unit 16, a determination unit 162 that determines whether the driving action of the driver P1 corresponds to the defense driving using the information acquired by the acquisition unit 161, and a provision unit 164 that classifies the defense driving according to the behavior of the vehicle 100 and the surrounding situation of the vehicle 100 in a case where the determination unit 162 determines that the driving action corresponds to the defense driving and provides a benefit to the driver P1 based on the classification result.

For example, the driver P1 can be made aware of the defense driving by providing the driver P1 with a benefit ranked based on the driving action based on the predictive prediction of the driver P1 and the classification result according to the result (the behavior of the vehicle 100 and the surrounding situation).

Specifically, it is possible to improve acceptability and continuity of the driver P1 with respect to the defense driving evaluation by providing the benefit. In addition, since the benefit related to the rating on the defense driving is given, the driver P1 can feel that his/her own defense driving is ranked higher.
(2) The defense driving evaluation apparatus 200 of (1) further includes a prediction unit 165 that predicts a future danger based on the behavior of the vehicle 100 and the surrounding situation of the vehicle 100, and the determination unit 162 determines the driving action for avoiding the danger predicted by the prediction unit 165 as the defense driving.

It is possible to improve acceptability and continuity to the defense driving evaluation by providing a benefit to be an incentive to the driver P1 who has taken a driving action for avoiding the danger predicted by the prediction unit 165.
(3) The defense driving evaluation apparatus 200 of (2) further includes an output unit 168 that outputs a display indicating an event of the predicted danger to the projection unit 52 serving as a display unit in a case where the driver P1 does not take a driving action corresponding to the defense driving to avoid danger predicted by the prediction unit 165.

For example, it is possible to provide the content introducing the corresponding dangerous scene to the driver P1 whose additional point is 0 (zero) in the above-described rating. It is possible to give the driver P1 a sense of crisis and awareness and to further enhance the consciousness of the defense driving by outputting content indicating a specific event that may occur in a case where the defense driving is not performed.
(4) The defense driving evaluation apparatus 200 of (2) further includes a rear lamp lighting device control unit 166 that performs blinking control on at least one rear lamp lighting device (hazard lamp, brake lamp) of the vehicle 100 in a case where regenerative braking (or engine braking) is generated by a regenerative braking control unit of the vehicle 100 and deceleration is performed at a predetermined deceleration.

With this configuration, for example, when the driver P1 senses danger and performs defense driving to release the accelerator pedal operation, at least one lamp light device of the hazard lamp and the brake lamp at the rear of the vehicle 100 is blinking controlled after deceleration is performed at a predetermined deceleration by regenerative braking, so that the traffic participant behind the vehicle 100 can be notified of the danger in front of the vehicle 100. In particular, it is possible to notify the following vehicle of the danger at an early stage, and there is an effect that a rear-end accident of the other vehicle to the own vehicle can be prevented in advance, so that a secondary effect that the defense driving action of the driver P1 also contributes to the safety around the own vehicle and the smooth traffic can be expected.

The above-described embodiments may be modified into various modes. Hereinafter, modified examples will be described.

### First Modified Example

In the above-described embodiment, an example has been described in which the defense driving evaluation apparatus 200 for each vehicle 100 evaluates the defense driving of the driver P1 and grants a benefit to the driver P1, but the server device 400 of FIG. 1A connected to the vehicle 100 via the public communication network 300 may bear a part of the defense driving evaluation processing performed for each vehicle 100.

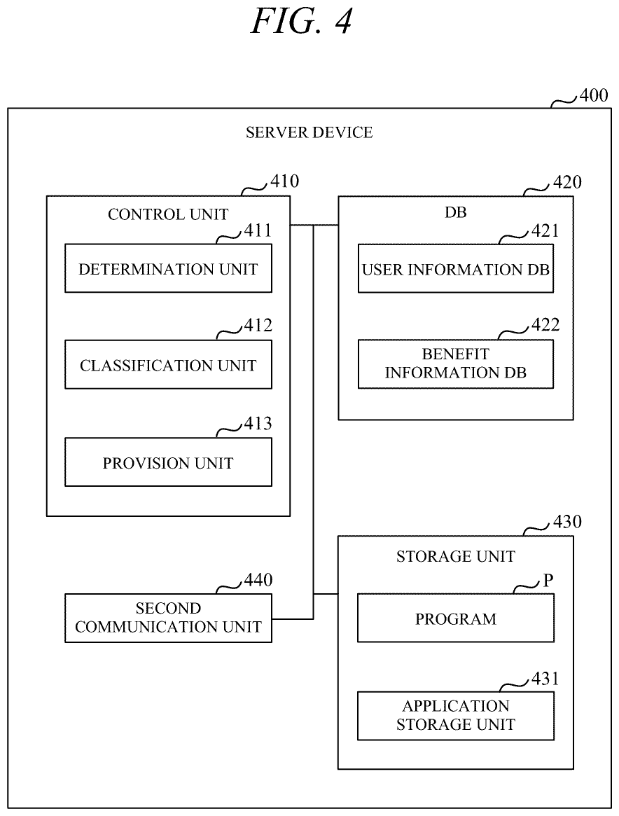

FIG. 4 is a block diagram illustrating a configuration of a main part of the server device 400 serving as an information processing device according to a first modified example.

The server device 400 includes a control unit 410, database (hereinafter referred to as DB) 420, storage unit 430, and second communication unit 440. The control unit 410 includes an arithmetic processing unit such as a Central Processing Unit (CPU) or a Micro Processing Unit (MPU), and performs various types of information processing, control processing, and the like necessary for the server device 400 by reading and executing the program P stored in the storage unit 430.

The control unit 410 includes a determination unit 411, a classification unit 412, and a provision unit 413 as functional configurations for the defense driving evaluation.

The determination unit 411 acquires the information regarding the driving action acquired by acquisition unit 161 of each vehicle 100 via the second communication unit 440 described later, and performs processing similar to that of the determination unit 162 described above on the driving action of the driver P1 of each vehicle 100.

The classification unit 412 performs processing similar to that of the classification unit 163 described above on the defense driving of the driver P1 of each vehicle 100.

The provision unit 413 performs processing similar to that of the provision unit 164 described above on the driver P1 who has performed defense driving of each vehicle 100.

The DB 420 is a large-capacity storage device including, for example, a hard disk or the like. The DB 420 includes a user information DB 421 and a benefit information DB 422. The user information DB 421 stores predetermined registration information regarding a user (the driver P1 of each vehicle 100) registered in advance. In addition, the benefit information DB 422 stores benefit information serving as content given for each driver P1. The benefit information stored in the benefit information storage unit 170 of each vehicle 100 is originally stored in the benefit information DB 422.

In the embodiment, the storage unit 430 and the DB 420 may be configured as an integrated storage device. Furthermore, the DB 420 may include a plurality of storage devices. Furthermore, the DB 420 may be an external storage device connected to the server device 400.

The storage unit 430 includes a storage element such as a Random Access Memory (RAM) or a Read Only Memory (ROM), and stores a program P, data, or the like necessary for the control unit 410 to execute processing. In addition, the storage unit 430 temporarily stores data and the like necessary for the control unit 410 to execute arithmetic processing. The storage unit 430 further includes an application storage unit 431 that stores a defense driving evaluation program (application program, hereinafter simply referred to as an application) to be provided to the in-vehicle device 14 of the vehicle 100 for which the application is desired to be provided.

The second communication unit 440 includes a processing circuit or the like for performing processing related to communication, and transmits and receives information to and from an external device such as the in-vehicle device 14 via the public communication network 300.

According to the defense driving evaluation system 500, the following operational effects can be obtained. That is, an in-vehicle device 14 mounted on each of a plurality of vehicles 100 (100A, 100B), and including a vehicle sensor group 12 serving as a detection unit that detects a behavior of each vehicle 100, a control unit 16 serving as a recognition unit that recognizes surroundings of each vehicle 100, an acquisition unit 161 that acquires information related to driving action of a driver P1 (P1A, P1B) of each vehicle 100 based on a behavior of each vehicle 100 detected by the vehicle sensor group 12 and surrounding situation of each vehicle 100 recognized by the control unit 16, a first communication unit 180 that performs communicating with a server device 400 serving as an information management device, and the server device 400 including a second communication unit 440 that performs communication with the first communication unit 180 of each vehicle 100, a determination unit 411 that determines whether the driving action of the driver P1 (P1A, P1B) of each vehicle 100 corresponds to defense driving by using information related to driving action from each vehicle 100 input via the second communication unit 440, and a provision unit 413 that, in a case where the determination unit 411 determines that the driving action corresponds to the defense driving, classifies the defense driving according to the behavior of each vehicle 100 from each vehicle 100 and the surrounding situation of each vehicle 100 input via the second communication unit 440 and provides a benefit to the driver P1 (P1A, P1B) of each vehicle 100 based on the classification result, are provided.

With such a configuration, in addition to making the driver P1 aware of the defense driving, it is possible to simplify the in-vehicle device 14 of each vehicle 100 by placing a part of the configuration of the in-vehicle device 14 of FIG. 1B on the server device 400 that is an external device when viewed from each vehicle 100 and distributing the processing.

Furthermore, it is possible to improve software maintainability such as update and improvement of the defense driving evaluation program.

The server device 400 may be applied to an edge computer having high real-time property and data governance property in addition to a cloud type that simply performs data distribution.

Furthermore, information can be shared among the vehicles 100 by accessing the server device 400 at the time of the defense driving evaluation. When the driver P1A of the vehicle 100A and the driver P1B of the vehicle 100B share the information regarding the defense driving, the defense driving of both of the drivers P1A and P1B can be compared and used for the future defense driving.

### Second Modified Example

In the above-described embodiment, five driving actions are exemplified as the defense driving, but the driving action is not limited to the exemplified driving action, and may be treated in a similar manner as the exemplified driving action as long as the driving action is for avoiding a danger that may lead to an accident. For example, in a case where the recognition unit detects a driving act (threatening act by sudden approach, sudden brake, shifting, meandering driving, persistent klaxon or passing, etc.) by another vehicle having a risk of threatening safe traveling of the own vehicle at around the own vehicle, an action of operating the own vehicle in a direction of moving away from the other vehicle may also be included in the defense driving.

In addition, an example in which a benefit is provided to the driver P1 every time the driver performs a driving action corresponding to the defense driving has been introduced, but contents having the content of praising may be provided every time the cumulative number of times of defense driving reaches a predetermined number of times. However, it is desirable to provide the content introducing the dangerous scene to the driver P1 early.

The above embodiment can be combined as desired with one or more of the aforesaid modifications. The modifications can also be combined with one another.

According to the present invention, it becomes possible to enlighten the driver about defense driving.

Above, while the present invention has been described with reference to the preferred embodiments thereof, it will be understood, by those skilled in the art, that various changes and modifications may be made thereto without departing from the scope of the appended claims.

1. A defense driving evaluation apparatus, comprising:
a sensor configured to detect a behavior of a vehicle; and
an in-vehicle device having a processor and a memory coupled to the processor, wherein
the in-vehicle device is configured to perform:
recognizing a surrounding situation of the vehicle;
acquiring driving action information relating to a driving action of a driver of the vehicle based on the behavior of the vehicle and the surrounding situation of the vehicle;
determining whether the driving action corresponds to a defense driving using the driving action information;
classifying the defense driving according to the behavior of the vehicle and the surrounding situation of the vehicle when it is determined that the driving action corresponds to the defense driving; and
providing a benefit to the driver based on a classification result.

2. The defense driving evaluation apparatus according to claim 1, wherein
the in-vehicle device is configured to perform:
predicting a future danger based on the behavior of the vehicle and the surrounding situation of the vehicle; and
determining the driving action for avoiding the danger as the defense driving.

3. The defense driving evaluation apparatus according to claim 2, wherein
the in-vehicle device is configured to perform:
outputting a display indicating an event of the danger to a display unit when the driver does not take the driving action corresponding to the defense driving to avoid the danger.

4. The defense driving evaluation apparatus according to claim 2, wherein
the in-vehicle device is configured to perform:
blinking control on at least one rear lamp lighting device of the vehicle when the vehicle is decelerated at a predetermined deceleration by a regenerative braking.

5. A defense driving evaluation system, comprising:
an in-vehicle device mounted on each of a plurality of vehicles and configured to perform recognizing a surrounding situation of each of the plurality of vehicles, acquiring driving action information relating to a driving action of a driver of each of the plurality of vehicles based on a behavior of each of the plurality of vehicles detected by a sensor and the surrounding situation of each of the plurality of vehicles, and communicating with a server device; and
the server device configured to perform communicating with the in-vehicle device mounted on each of the plurality of vehicles, determining whether the driving action of the driver of each or the plurality of vehicles corresponds to a defense driving using the driving action information from each of the plurality of vehicles, classifying the defense driving according to the behavior of each of the plurality of vehicles and the surrounding situation of each of the plurality of vehicles when it is determined that the driving action corresponds to the defense driving, and providing a benefit to the driver of each of the plurality of vehicles based on a classification result.
